(19) United States
(12) Patent Application Publication
(10) Pub. No.: US 2007/0008305 A1
(43) Pub. Date: Jan. 11, 2007

(54) Multiple function radio bezel interface

(75) Inventors: John Thomas Kosinski II, River Rouge, MI (US); Shadi Mere, Ypsilanti, MI (US); Terrence Dale Prestel, Livonia, MI (US); Scott Dittman, Monroe, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/168,552

(22) Filed: Jun. 28, 2005

(51) Int. Cl. G09G 5/00

(52) U.S. Cl. 345/184

(57) ABSTRACT

A multiple function radio bezel interface includes a display screen, a first knob assembly including an outer ring and an inner knob, the outer ring adapted to allow a user to select an application from a multimedia main menu and the inner knob adapted to allow a user to selectively power the radio bezel interface and to adjust the volume of the radio, and a second knob assembly including an outer ring and an inner knob, the outer ring adapted to allow a user to select different application screens corresponding to the application selected from the multimedia main menu and the inner knob being a jog controller.

### FIELD OF THE INVENTION

The present invention relates to a multiple function radio bezel interface that provides a reduced number of controls.

### BACKGROUND OF THE INVENTION

Modern vehicles include many systems that the operator of the vehicle must interface with. Many vehicle include navigation systems, and stereo systems with radio, CD, and DVD players included. In order to allow the operator of the vehicle to operate all of these systems while seated in the driver seat, it is desireable to provide an interface that allows the operator to control all of these systems. However, interfaces of this type typically include many knobs, dials, and buttons, to provide individual controls for each system. This makes it cumbersome for the operator to use the interface. Therefore, there is a need for a multiple function interface that allows the operator to control several systems with minimal controls.

### SUMMARY OF THE INVENTION

In an aspect of the present invention, a multiple function radio bezel interface is provided wherein the interface includes a a display screen, a first knob assembly and a second knob assembly. The first knob assembly includes an outer ring and an inner knob. The outer ring of the first knob assembly is adapted to allow a user to select an application from a multimedia main menu and the inner knob is adapted to allow a user to selectively power the radio bezel interface and to adjust the volume of the radio. The second knob assembly includes an outer ring and an inner knob. The outer ring of the second knob assembly is adapted to allow a user to select different application screens corresponding to the application selected from the multimedia main menu. The inner knob of the second knob assembly is a jog controller.

In another aspect of the present invention the jog controller provides six different input modes. The operator can momentarily press and release the jog controller, press and hold the jog controller, momentarily turn and release the jog controller in the clockwise or counterclockwise direction, or turn and hold the jog controller in the clockwise or counterclockwise direction.

In yet another aspect of the present invention, the inner knob of the first knob assembly provides two different input modes. In a first input mode, the inner knob of the first knob assembly is a 34 step, 360 degree detent encoder to allow adjustment of the volume of the radio. In a second input mode, the inner knob of the first knob assembly is a push button to turn the interface on and off.

In still another aspect, each of the outer rings of the first and second knob assemblies include a 20 step, 360 degree detent encoder. When the outer ring of the first knob assembly is turned, the multimedia main menu appears on the display screen, the current application is outlined, and further turning of the outer ring of the first knob assembly highlights, in turn, other applications that may be selected. When the outer ring of the second knob assembly is turned the different application screens associated with the selected application from the multimedia main menu appear, in turn, on the display screen as the outer ring of the second knob assembly is turned.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a multiple function radio bezel interface in accordance with the teachings of the claims herein; and

FIG. 2 is a front view of the interface shown in FIG. 1.

### DESCRIPTION OF THE EMBODIMENTS

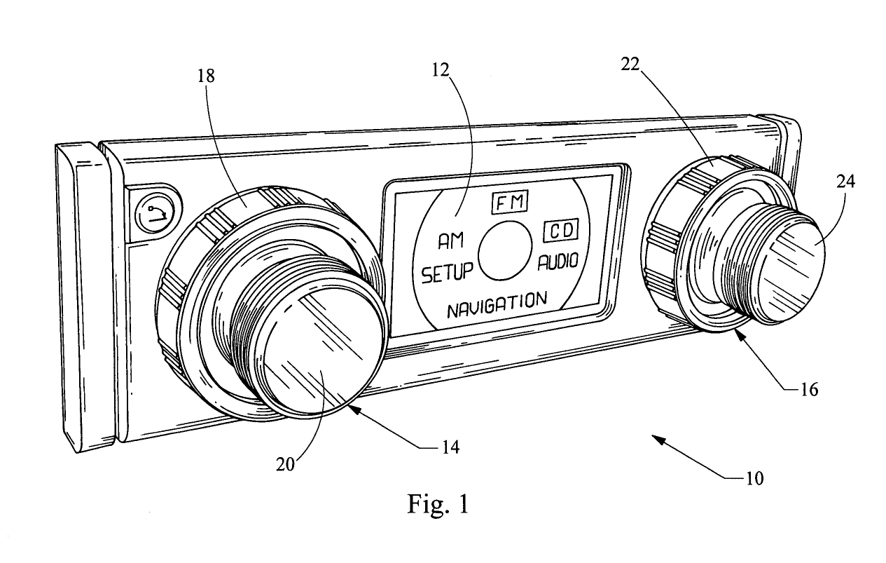

Referring to FIG. 1, a multiple function radio bezel interface in accordance with the teachings of the claims herein is shown generally at 10. The multiple function radio bezel includes a display screen 12, a first knob assembly 14 and a second knob assembly 16.

The first knob assembly 14 includes an outer ring 18 and an inner knob 20. The outer ring 18 of the first knob assembly 14 is adapted to allow a user to select an application from a multimedia main menu displayed on the display screen 12. Preferably, the outer ring 18 of the first knob assembly 14 includes a 20 step, 360 degree detent encoder.

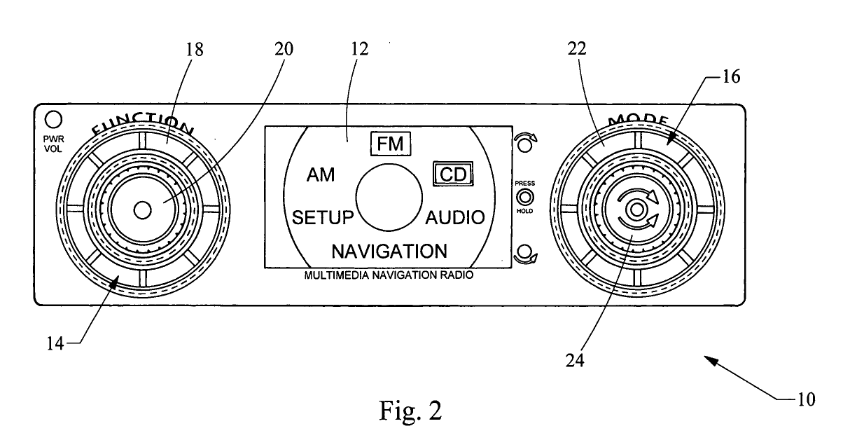

When the outer ring 18 of the first knob assembly 14 is turned the multimedia main menu appears on the display screen 12. Referring to FIG. 2, an example of a multimedia main menu is displayed on the display screen 12. The multimedia main menu includes a plurality of applications from which the operator can select. As shown, the multimedia main menu applications include: AM, FM, CD, AUDIO, NAVIGATION, and SETUP. It is to be understood that this particular set of applications is for illustrative purposes only. The multimedia main menu could include other applications not shown here, alone or in combination with the example applications shown.

When the operator of the vehicle turns the outer ring 18 of the first knob assembly 14 the multimedia main menu appears on the display screen 12. The current application is outlined. As shown, the application CD is outlined, indicating that the multiple function radio bezel interface 10 is currently set to allow the operator to set and adjust the controls for the CD player of the vehicle. If the operator of the vehicle continues to turn the outer ring 18 of the first knob assembly 14, the other applications displayed on the multimedia main menu are highlighted in turn. This allows the operator to toggle through the applications until the desired application is highlighted. As shown, the FM application is highlighted. Once the desired application is highlighted, the operator can select that application using one of the other controls on the multiple function radio bezel interface. Alternatively, after 0.5 seconds of inactivity, the highlighted application will automatically be selected, thereby setting the multiple function rado bezel interface to allow the operator to set and adjust the controls for the newly selected application.

The inner knob 20 of the first knob assembly is adapted to allow the operator to selectively turn the power to the radio bezel interface on and off and to adjust the volume. Preferably, the inner knob 20 of the first knob assembly 14 provides two different input modes. The first input mode includes a 34 step, 360 degree detent encoder to allow adjustment of the volume of the radio by turning the inner knob 20 of the first knob assembly 14. The second mode is a push bottom, wherein pushing the inner knob 20 of the first knob assembly 14 turns the power on or off.

The second knob assembly 16 includes an outer ring 22 and an inner knob 24 as well. The outer ring 22 of the second knob assembly 16 is adapted to allow a user to select from a plurality of different application screens corresponding to the application selected from the multimedia main menu. Preferably, the outer ring 22 of the second knob assembly 16 includes a 20 step, 360 degree detent encoder.

Once an application is selected from the multimedia main menu, when the operator turns the outer ring 22 of the second knob assembly, different applications screens will be displayed, in turn, on the display screen 12. These application screens correspond to the selected application. For example, if the CD application was selected, then turning the outer ring 22 of the second knob assembly 16 would display, in turn, different application screens allowing the operator to set or adjust controls for the CD player.

The inner knob 24 of the second knob assembly 16 is a jog controller, preferably having six different input modes. The operator can momentarily press and release the inner knob 24, press and hold the inner knob 24, momentarily turn and release the inner knob 24 in the clockwise or counterclockwise direction, or turn and hold the inner knob 24 in the clockwise or counterclockwise direction.

Once the operator has selected a particular application from the multimedia main menu using the outer ring 18 of the first knob assembly 14, and has toggled to a desired application screen, associated with the particular application, using the outer ring 22 of the second knob assembly 16, then the operator can set or adjust the controls on that application screen, for that chosen application, using the inner knobs 20, 24 of the first and second knob assemblies 14, 16.

For example, the operator uses the outer ring 18 of the first knob assembly 14 to select the FM application. Then, the operator uses the outer ring 22 of the second knob assembly 16 to toggle to an application screen for selecting an FM radio station. Then, the operator uses the inner knob 24 of the second knob assembly 16 to select a particular FM radio station. The operator might momentarily turn and release the inner knob 24 to tune to a particular FM station, or the operator might turn and hold the inner knob 24 to activate a seek function. Once the operator has found a station, the inner knob 24 can be pushed and held to set that station as a pre-set.

In another example, the operator uses the outer ring 18 of the first knob assembly 14 to select the NAVIGATION application. Then the operator uses the outer ring 22 of the second knob assembly 16 to toggle to an application screen associated with the NAVIGATION application. The operator can use the inner knob 24 of the second knob assembly 16 to use different functions of the NAVIGATION system of the vehicle. The operator might momentarily turn and release the inner knob 24 to toggle between various maps of the area. The operator might turn and hold the inner knob 24 to move the map or push and hold the inner knob 24 to zoom in on a particular portion of the displayed map.

The examples given above are merely for illustrative purposes. The multiple function radio bezel interface 10 allows the operator of a vehicle or passenger of a vehicle to control several different systems within the vehicle while only requiring the operator to find and operate two different knob assemblies 14, 16. The multiple function radio bezel interface could be used with any applications that are associated with an automotive vehicle, and the outer rings 18, 22 and inner knobs 20, 24 could be used to control those systems in ways other than described herein.

In accordance with the provisions of the patent statutes, the present invention has been described in what is considered to represent its preferred embodiment. However, it should be noted that the invention can be practiced otherwise than as specifically illustrated and described.

What is claimed is:

1. A multiple function radio bezel interface comprising:
a display screen;
a first knob assembly including an outer ring and an inner knob, the outer ring adapted to allow a user to select an application from a multimedia main menu and the inner knob adapted to allow a user to selectively power the radio bezel interface and to adjust the volume of the radio; and
a second knob assembly including an outer ring and an inner knob, the outer ring adapted to allow a user to select different application screens corresponding to the application selected from the multimedia main menu and the inner knob being a jog controller.

2. The multiple function radio bezel interface of claim 1 wherein the jog controller provides six different input modes wherein the user can momentarily press and release the jog controller, press and hold the jog controller, momentarily turn and release the jog controller in the clockwise or counterclockwise direction, or turn and hold the jog controller in the clockwise or counterclockwise direction.

3. The multiple function radio bezel interface of claim 1 wherein the inner knob of the first knob assembly provides two different input modes wherein the inner knob of the first knob assembly is a 34 step, 360 degree detent encoder to allow adjustment of the volume of the radio by turning and the inner knob of the first knob assembly is also a push button to turn the interface on and off.

4. The multiple function radio bezel interface of claim 1 wherein each of the outer rings of the first and second knob assemblies include a 20 step, 360 degree detent encoder.

5. The multiple function radio bezel interface of claim 4 wherein when the outer ring of the first knob assembly is turned the multimedia main menu appears on the display screen, the current application is outlined, and further turning of the outer ring of the first knob assembly highlights, in turn, other applications that may be selected.

6. The multiple function radio bezel interface of claim 5 wherein after 0.5 seconds of inactivity, the highlighted application is selected.

7. The multiple function radio bezel interface of claim 5 wherein when the outer ring of the second knob assembly is turned the different application screens associated with the selected application from the multimedia main menu appear, in turn, on the display screen as the outer ring of the second knob assembly is turned.

8. A multiple function radio bezel interface comprising:
a display screen;
a first knob assembly including an outer ring and an inner knob;
the outer ring of the first knob assembly being a 20 step, 360 degree detent encoder, wherein, when the outer ring of the first knob assembly is turned a multimedia main menu appears on the display screen, the current application is outlined, and further turning of the outer ring of the first knob assembly highlights, in turn, other applications that may be selected, wherein after 0.5 seconds of inactivity, the highlighted application is selected;
the inner knob of the first knob assembly having two input modes, a first input mode being a 34 step, 360 degree detent encoder to allow the volume of the radio to be adjusted by turning, and a second input mode being a push button adapted to allow the power to be turned on and off by pushing the inner knob of the first knob assembly; and
a second knob assembly including an outer ring and an inner knob;
the outer ring of the second knob assembly being a 20 step, 360 degree detent encoder, wherein, when the outer ring of the second knob assembly is turned the different application screens associated with the selected application from the multimedia main menu appear, in turn, on the display screen as the outer ring of the second knob assembly is turned;
the inner knob of the second knob assembly being a jog controller having six input modes wherein the operator can momentarily press and release the jog controller, press and hold the jog controller, momentarily turn and release the jog controller in the clockwise or counterclockwise direction, or turn and hold the jog controller in the clockwise or counterclockwise direction.
